(19) United States
(12) Patent Application Publication
(10) Pub. No.: US 2026/0065225 A1
(43) Pub. Date: Mar. 5, 2026

(54) LOW RESOLUTION REAL-TIME LOCATING SYSTEMS (RTLS)

(71) Applicant: Avery Dennison Retail Information Services LLC, Mentor, OH (US)

(72) Inventor: Mark W. ROTH, North Miami, FL (US)

(21) Appl. No.: 19/106,728

(22) PCT Filed: Sep. 8, 2023
(86) PCT No.: PCT/IB2023/058937

§ 371 Date: Feb. 26, 2025

Related U.S. Application Data
(60) Provisional application No. 63/375,100, filed on Sep. 9, 2022.

(51) Int. Cl. G06Q 10/087

(52) U.S. Cl. CPC G06Q 10/08724

(57) ABSTRACT

In accordance with some embodiments, an item identification system is disclosed. The item identification system may include a user interaction device configured to receive inputs from one or more users identifying a requested item. The item identification system may include at least one item identifier communicably coupled to the one or more user interaction devices, and adapted to receive inputs from the one or more users and to perform operations based on inputs provided. The item identification system may also include a plurality of antennas, and a plurality of indicators operatively coupled to the at least one item identifier. The plurality of indicators may be adapted to transmit a responsive output signal based on inputs received from the at least one item identifier and at least one of the plurality of antennas.

### TECHNICAL FIELD

The present disclosure, in general, relates to the field of inventory locating systems and methods. In some embodiments, the present disclosure relates to an item identification system comprising at least one item identifier operatively coupled to a user interaction device to receive inputs from one or more users and to help locate an item. In some embodiments, the item identification system comprises one or more indicators operatively coupled to the at least one item identifier. The one or more indicators are configured to transmit a responsive output signal based on inputs received from the at least one item identifier. Moreover, the responsive output signal triggers an indication on at least one of the plurality of indicators in the proximity of a desired item.

### BACKGROUND

Traditionally, inventory products have been identified with the use of barcode labels. Barcodes allow for the individual scanning of each item that can be visually witnessed. However, if items/cartons are stacked, and have barcode labels, each item may need to be handled to position the label to allow proper scanning. It may be appreciated that, each barcode label needs line of sight to allow the barcode scanner to scan. Additionally, it may be understood that larger volumes of items or cartons having barcode labels would take a very long time to scan to obtain a complete inventory.

Advancements were made and RFID technology was introduced to overcome the above limitations. The use of RFID technology has helped to improve the ability to more efficiently and find inventory within a facility as there is no requirement of line of sight to acquire data. The use of RFID overcomes the “line of sight” disadvantage experienced with barcode technologies. With proper RFID equipment, possibilities have been made to collect total inventory counts very quickly and without having to reposition or handle each item. The use of radio frequency can propagate through a variety of materials to energize the RFID transponder and obtain its stored data independent of label visibility.

In a very large (e.g., 100,000 sq. ft. plus) types of warehouse environment, a hand-held reader would be impractical and ineffective because it could take an employee hours to locate items by walking up and down aisles with a hand-held reader.

In some such environments, a fixed reader may be mounted overhead mounted readers with complex technologies such as beam steering or phased array designs intended to locate exactly where multiple items exists and are moving within the readable space based on precise measurements. Such systems may be prohibitively expensive for a single unit and still fail to identify where amongst multiple rows an item may be found if a single reader is used or if triangulation fails.

Therefore, in light of foregoing discussions, there is a need to overcome the limitations and disadvantages related to conventional item identification systems and methods to improve and enhance the ongoing demand and supply in the global market.

### SUMMARY

Some embodiments of the present subject matter provide a system or a method that can identify and/or indicate at least one item in a plurality of items. Some embodiments include an item identification system to identify and/or indicate at least one item. Some embodiments of the present subject matter provide a user interaction device configured to receive inputs from one or more users. Some embodiments include at least one item identifier communicably coupled to the one or more user interaction devices. In some embodiments, the at least one item identifier is adapted to receive inputs from one or more users and perform operations based on inputs provided by the user interaction device.

Some embodiments use a Low-Resolution Real-Time Locating Systems (RTLS) solution, that may provide advantages with respect to cost, range, and/or speed. For example, some embodiments use a device such as a four facetted upside-down pyramid having a flat top, and having a very broad beam antenna on one or more faces, which may allow for a wide and vertical reach of broadcast RF signal. For some embodiments, the item identification system may be referred as “apex” reader solution, acts as a general location beacon to aid the user searching for items to have a more concise means to locate desired items.

In various embodiments, multiple apex units may be deployed along the length of an aisle, such as on the floor, on a wall or shelf, on a pole above a shelf, or on the ceiling. For some embodiments, at the end of the aisle would be a strobe or light indicator tied to the apex platform. To initiate the search, for some embodiments, the user may key into a handheld device a name, number, or key word associated with the item in question. This could be the specific EPC value attached to the item or a category of same items.

In various embodiments, the user may generate a request from a mobile device (e.g., a cellular device) to one, some, or all readers or to a system configured to relay the request to one, some, or all readers within a given storage location. Furthermore, while responding to the inputs provided, one, some, or all of the readers may turn on and/or report regarding one, some, or all wireless tags within the view of each apex node and to the nearby apex nodes. In such an instance, the request may be transferred from one location to another and based on the proximity of the requested tag. In some embodiments, the request may be relayed from node to node or to a plurality of nodes. In various embodiments, the relay operates after determining that the requested tag is or isn't within the field of view of the current node. In another example, the request may be sent directly or via a server, such as a local or remote server.

In some embodiments, each tag list report is compared from each reader node to the selected item would be created at each respective node, at a server location, or by the handheld device. Furthermore, the item is located on a specific apex node the information of its aisle location can be displayed on the handheld and or a light on the apex will be illuminated indicating the general location of the item. Each apex node may have one or more sides or facets, each containing an antenna. Additionally, in some embodiments, the facet (antenna) that “sees” the RFID tagged item may have a corresponding indicator light. So not only will the user know what aisle the item has been located, the apex will indicate the direction it was seen. For various embodiments, it can be extremely valuable to provide an efficient means to quickly locate items in an aisle with racks on both sides. Again, for various embodiments, this solution uses a lower-resolution zone read. Therefore, some embodiments further include use of an RFID handheld to perform the granular function of finding the specific item among similar items.

It may be appreciated that the term “item” in the context of the present subject matter, only guides the reader in understanding the functionality of the search apparatus using the apex platform. In inclusive to the various embodiments, and within the scope, “Item” therefore may include an individual box, package, bottle, consumer good, fruit, vegetable, clothing article, book, phone, computer, newspaper, pallet, crate, or other object.

In various embodiments, each of the aisles includes indicator lights and each may indicate state of use. For instance, green colored signal may simply indicate the lane and the devices are active. The color red may indicate the aisle the RFID item is detected and what general location or zone within that aisle. As will be further described in the software platform portion of this disclosure, a terminal interface or hand-held device may initiate the inquiry as to the location of said item, carton or pallet.

In some embodiments, the present subject matter includes a low-cost node with multiple fixed facet antennas having broad yet defined coverage. The present subject matter provides a low-cost alternative to conventional overhead options, making it feasible to deploy numerous nodes to achieve coverage over broad areas. Some embodiments provide critical feedback to an associate with visual cues as to where an item is located. So as the associate who is searching for a specific item, thereby maybe guided more efficiently to where the item may be in a given aisle as well as in what rack location. The solution can remain low cost because it can be used to indicate what shelf to look at. For example, the fixed antenna facets of some embodiments provide a low-resolution solution to efficiently position the associate in the general area more quickly since they are also combined with visual indicators. In some embodiments, the system points the associate to the right zone (aisle/rack). The associate still can utilize hand devices held for granular resolution search for specific item. In various embodiments, an indicator such as an LED light associate with each antenna that lights up indicating what zone the item is being “seen” by the reader. As can now be appreciated, these embodiments can assist an associate in a large warehouse to more quickly get closer to the desired items.

These and other features, aspects, embodiments, and advantages of the present subject matter will be better understood with reference to the following description and appended claims. This summary is provided to introduce a selection of concepts in a simplified form. This summary is not intended to identify key features or essential features of the claimed or disclosed subject matter, nor is it intended to be used to limit the scope of the claimed subject matter.

### BRIEF DESCRIPTION OF DRAWINGS

The summary above, as well as the following detailed description of illustrative embodiments, is better understood when read in conjunction with the appended drawings. For the purpose of illustrating the present subject matter, exemplary constructions of the subject matter are shown in the drawings. However, the present subject matter is not limited to specific methods and instrumentalities disclosed herein. Moreover, those in the art will understand that the drawings are not to scale. Wherever possible, like elements have been indicated by identical numbers.

Embodiments of the present subject matter will now be described, by way of example only, with reference to the following diagrams wherein:

FIG. 1 is a block diagram of an item identification system, in accordance with some embodiments of the present subject matter;

FIGS. 2A and 2B are illustrations of the item identification system, in accordance with some embodiments of the present subject matter;

FIG. 3A is a schematic diagram of an inventory area including the item identification system deployed therein, in accordance with various embodiments of the present subject matter;

FIG. 3B is an illustration of a portal reader in accordance with some embodiments of the present subject matter;

FIG. 4 is an illustration of a flow chart of a method for locating an item, in accordance with some exemplary embodiments of the present subject matter;

FIG. 5 is an illustration of a block diagram representing electrical components in accordance with some embodiments of the present subject matter.

In the accompanying drawings, an underlined number is employed to represent an item over which the under lined number is positioned or an item to which the under lined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In overview, some embodiments of the present subject matter relate to identifying association of an entity. Some embodiments include providing validated associations of the entity, and the associations may be determined based on at least one of: recency, frequency, proximity, and semantics thereof.

The following detailed description illustrates various embodiments of the present subject matter and ways in which they can be implemented. Although some modes of carrying out the present subject matter have been disclosed, those skilled in the art would recognize that other embodiments for carrying out or practicing the present subject matter are also possible. Some disclosed embodiments include one or more of methods, devices, and/or systems for locating, identifying, and/or communicating about items, goods, articles, inventory items, and goods have been disclosed herein.

In an aspect, embodiments of the present subject matter provide at least part of an item identification system. The item identification system comprises:
a user interaction device configured to receive inputs from one or more users;
at least one item identifier communicably coupled to the one or more user interaction devices, and adapted to receive inputs from one or more users and perform operations based on inputs provided; and
a plurality of indicators operatively coupled to the at least one item identifier, and adapted to transmit a responsive output signal based on inputs received from the at least one item identifier.

In another aspect, some embodiments of the present subject matter provide a method for locating an item. The method comprises:
receiving inputs from users via a user interaction device;
retrieving information based on inputs provided by the user interaction device;
scanning aisles and items to locate a target item in the aisle; and
generating responsive output signals based on an availability of the target item therein.

Throughout the present subject matter, the term “item identification system” refers to an arrangement of one or more devices in various embodiments that enables or otherwise supports an efficient, cost effective, and time saving item identification and indication to locate a desired item. Furthermore, the item identification system in some embodiments as used herein enables determination of a location of an item in a plurality of racks and aisles in a predefined area or non-predefined area. Moreover, in some embodiments, the item identification system provides information about availability or presence of the item in the rack or aisle. Moreover, the item identification system as disclosed in the present disclosure enables a responsive signal as a visual indication and/or an audio-visual indication in the proximity of the selected item or desired item.

The item identification system or method as used herein can be very beneficial for different industries or environments such as shopping complex, marts, shops, and/or showrooms. The locations where the item identification system or method may be used may include floor of shops, aisles of marts and malls, and super marts. The term “items” as used herein may include, but not limited to, inventory items, packages, boxes, couriers, goods, packets, packs, cartons, bundles, boxes, cases, and the like. As used herein, “items”, “at least one item”, “an item”, or “plurality of items” is used interchangeably in the subject matter. In some embodiments, the items or goods are equipped with wireless identification tags such as RFID tags, smart tags, and the like. For example, the wireless identification tags may include one or more of QR codes, barcodes, high frequency RFID tags, and low frequency RFID tags. Furthermore, the predefined area may include the space inside the shop or malls that is designed to accommodate or allow for stacking, arranging and storing of one or more articles, products, items, goods, or packages. In an example, the predefined area may include a compartmental area, a floor area, or a chamber inside the buildings, shops, and malls.

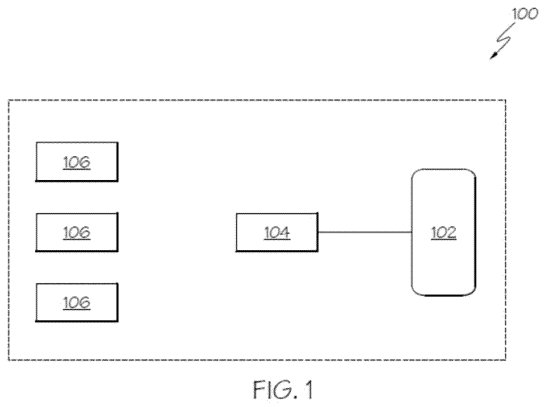

Referring to FIG. 1, there is shown an illustration of a block diagram of an item identification system 100, in accordance with an embodiment of the present subject matter. In some embodiments, the item delivery system 100 may include one or more of an item identification system, an item locating system, or an item indication system. The item identification system 100 as used herein includes item identification, item location and item indication in one or more embodiments. In some embodiments, the item identification system 100 may include item locating systems that guide users through aisles and/or racks to locate a desired item from the plurality of items stored in a plurality of racks or aisles present therein.

In various embodiments, the item identification system 100 comprises a user interaction device 102 configured to receive inputs from one or more users, such as via text message from the user's cell phone. In other embodiments, the item identification system 100 is the user's cell phone. The term “user interaction device” as used herein refers to client devices, servers, cellular devices, cellular transceivers, mobile devices, tablets, cellphones. The user interaction device 102 may include, but is not limited to, human machine interfaces and/or human computer interfaces that receives inputs from one or more users and transmits the inputs to one or more devices connected therewith. Such inputs may include, but are not limited to, a desired item, a selected design, a selected type, and/or a selected company product. For example, the input may include one or more of the following characteristics or combinations thereof: a 1) bath soap of 2) ABC company for a 3) woman's skin type with a 4) specific usage on 5) non-oily skin and in 6) lavender fragrance. In such an instance the selected soap is of a very specific item to be picked from a plurality of items in a shop or a mall, which may be difficult for a consumer to find using conventional methods.

In some embodiments, the item identification system 100 comprises at least one item identifier 104 communicably coupled to the one or more user interaction devices 102. The term “at least one item identifier” may refer to a plug-in-play command module that enables communication between connected devices and also facilitates transmission of instructions and signals. In an example, the at least one item identifier 104 may be connected over a connector device including a plug-in socket and/or a magnetic coupling. Furthermore, at least one item identifier 104 may include one or more microprocessors or micro controllers, a raspberry pi, microcomputers, or control circuits. According to an embodiment, the at least one item identifier 104 is adapted to receive inputs from one or more users and perform operations based on inputs. In some embodiments, the at least one item identifier 104 relays the information to another of the at least one item identifiers 104 located at another location in proximity to the first at least one item identifier 104. In this way, requests for response may be relayed from one device to another to extend the range of the initial request.

In various embodiments, the at least one item identifier 104 is adapted to receive inputs from one or more users and perform operations. In various embodiments, the at least one item identifier 104 is operable to perform detecting of one or more of wireless identification tags and/or QR codes of the items, identifying the items, and specifying a location of the item. The item identification system 100 may include one or more of QR code readers, RFID readers, barcode readers, or smart readers. The item identification system 100 may be configured to identify and locate at least one item from the plurality of items stored and/or arranged in a plurality of racks and/or aisles. In some embodiments, when the at least one item identifier 104 receives an input from a user requesting assistance with finding an item (e.g., via text message over a cellular network), the request is relayed by the at least one item identifier 104 to at least one additional item identifier 104.

In some embodiments, the item identification system 100 performs one or more of detecting, identifying, and/or locating wireless identification tags of the items such as RFID tags of the at least one item stored and/or arranged in a plurality of racks and/or aisles. According to an embodiment, the at least one item is equipped with one or more wireless identification devices. Furthermore, wireless identification devices may include one or more RFID tags, smart tags, QR codes, barcodes, high frequency RFID tags, and low frequency RFID tags. Moreover, the wireless identification devices comprise RFID tags configured with high frequency HF antenna and/or ultra-high frequency UHF antenna. In an embodiment, the at least one item identifier 104 further comprises a wireless identification reader and at least one antenna, the wireless identification reader being adapted to identify each of the plurality of items equipped with the wireless identification devices.

In various embodiments, the item identification system 100 comprises one or a plurality of indicators operatively coupled to the at least one item identifier 104. The plurality of indicators 106 is adapted to transmit a responsive output signal based on inputs received from the at least one item identifier 104. In some embodiments, the plurality of indicators 106 are static devices installed in static platforms. Moreover, the responsive output signal is based on an availability of an item in an aisle. The plurality of indicators 106 may be mounted on the floor area and/or mezzanine of a warehouse or a shop floor. Furthermore, in some embodiments, the responsive output signal includes an audible alert from the plurality of indicators. In an example, the audible alert may include an alarm sound and/or a buzzer sound. In some embodiments, the responsive output signal includes a visual alert from the plurality of indicators, such as to indicate proximity or to indicate that the item is within the field of view of an antenna adjacent to and/or on the same side of the item identification system 100. Furthermore, in some embodiments, the responsive output signal includes a visual alert from a plurality of indicators. In yet another embodiment, the visual alert from the plurality of indicators includes polychromatic lights. For example, the polychromatic lights may include lights of green color, red color, or any color, and a combination thereof. In some embodiments, the plurality of indicators is provided to an aisle indicator located at an end of an aisle.

In one embodiment, the indicator comprises an illumination module to project a light to locate the at least one item from the plurality of items stored and/or arranged in a plurality of racks and/or aisles. The illumination module may be configured to project monochromatic light, polychromatic lights, and the like on the plurality of items to specify and signify the location of the at least one item from the plurality of items stored and/or arranged in a plurality of racks and/or aisles. For example, the indicator may include one or more of a light pointer, a laser pointer, a light beam, a projected image, a light, or other illumination device. For example, in some embodiments, the indicator may distinctively illuminate the item, such as within a heap of items on a floor or shelf.

In some embodiments, the indicator may simply be a light mounted on a pole or an elongated member of the at least one item identifier 104 that indicates a general area where the item may be found relative to the at least one item identifier 104. The light may not illuminate the actual area where the item is located, but instead may give the user information regarding what direction to start looking in relative to the indicator light. In other embodiments, the indicator may illuminate an area where the object of interest may be found, such as on a floor or on a shelf using a light that brightens a region within which the item may be found. In some embodiments, the indicator may brighten and/or project light onto a specific area behind which the item of interest is located, such as a 10-inch diameter circular lighted area, a 12-inch diameter circular lighted area, or a 14-inch diameter circular lighted area. The area that is brightened may be smaller or larger, such as having a greatest length of under 1, 2, 4, 6, 8, 10, 15, 20, or 30 inches.

In some embodiments, the at least one user interaction device 102 is further configured to provide a signal to a proximity indicator based on the at least one user interaction device 102 being in proximity to a wireless identification tag. The at least one user interaction device 102 is provided with inputs such as a selected item or a desired item to be searched within a floor area of a mall or a shop. In such an instance, the at least one user interaction device 102 communicates with the at least one item identifier 104 to relay information to the at least one indicator in the proximity of the selected item or the desired item. Furthermore, the at least one indicator in the proximity of the selected item generates responsive output signal in audio and/or light form to indicate an availability and/or location of the selected item or the desired item. In various embodiments, the item identification system 100 further comprises a user interface communicably coupled to the at least one item identifier 104.

For some embodiments, the item identification system 100 may include a mobile application (e.g., installed on a user's mobile device or another user interaction device 102) that allows a user to provide an asset identification value that will be published to an MQTT broker on a defined message topic. Furthermore, the broker may publish the message to the Apex RFID reader units that are subscribed to the topic. Moreover, after and/or at the same time as activating the responsive signal, the Apex reader (e.g., item identifier 104) may also publish a message to the MQTT broker on a defined message topic to indicate its location is seeing the asset identification value. In an example, the mobile application may be subscribed to the message topic so that it receives the message and displays a visual cue (e.g., via an indicator 106) indicating which Apex unit's location is viewing the requested asset identification value. In some embodiments, the color or signal pattern of the indicator 106 may be used to indicate relative proximity, and the position of the indicator 106 (e.g., on one side of the item identifier 104) may be used to show the direction in which the item may be detected from the item identifier 104. Another larger indicator 106 (e.g., a central spotlight) on the same item identifier 106 may be used to spotlight which item identifier 104 is in range of the requested item. In some embodiments, item identifiers 104 may use a color and/or pattern of indicators to show what direction a user should travel to get to the item identifier 104 that is closest to the requested item. For example, a field of item identifiers 104 may all use a flashing blue light on one side of the item identifiers 104 to point inwards towards the item identifier 104 that is closest to the item, which may have a faster flashing, brighter, and/or red indicator 106 to indicate where the item may be found.

For various embodiments, after a “found” communication has been received by the mobile application, the mobile application may then switch to an RFID tag location function allowing the operator to go to the location indicated by the Apex reader that is seeing the asset identification value and locate the asset. For some embodiments, information may be provided in the way that a radioactive Geiger counter uses a tone or signal to indicate how hot, or in this case, how strong the signal is in reference to the user's position. This functionality may be audio and/or visual to the user to aid in an efficient search and location of the desired item.

For some embodiments, once the operator has located the asset they will indicate to the mobile application that it has been found and the mobile application will publish a message to the MQTT broker that will be received by the Apex reader causing it to deactivate the digital output. The matrix may then wait for the next “find” event request.

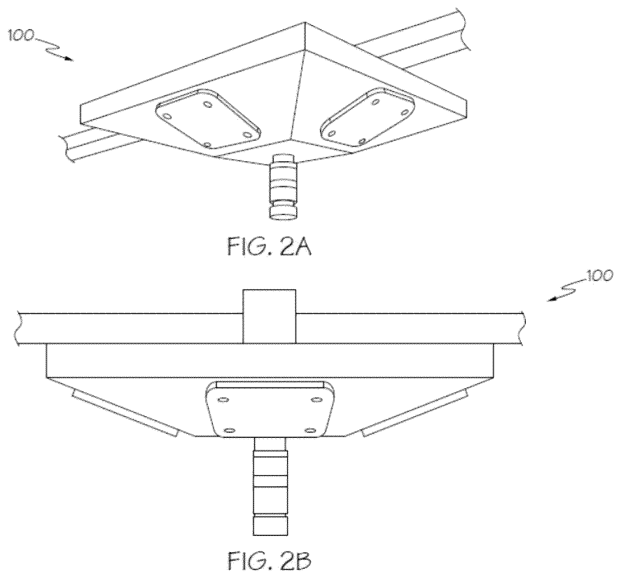

Referring to FIGS. 2A and 2B, there is shown illustrations of an item identification system 100, in accordance with an embodiment of the present subject matter. The item identification system 100 may be designed and structured in various dimensions, shapes and sizes based on requirement and applications. According to an embodiment of the present disclosure, the at least one item identifier 104 may be configured as a multi-sided pyramid, cone, or other structure having faces facing laterally away from the item identifier 104, and each face having a transmitter/antenna for detecting an RFID tag and an indicator 106. In some embodiments, an indicator 106 may be formed as a centrally mounted light or column of lights to light up when a single indicator 106 on a face of the item identifier 104 has been lit. In some embodiments, the at least one item identifier 104 may include at least four faces provided with at least one antenna of each of the faces to detect wireless identification devices configured inside the plurality of devices. In other embodiments, the number of faces may be 1, 2, 3, 5, 6, 7, or more.

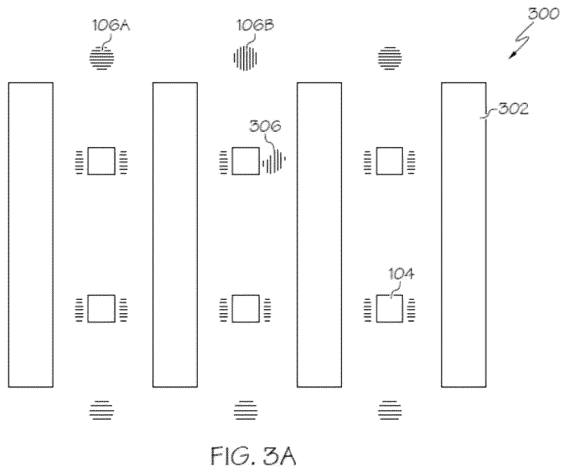

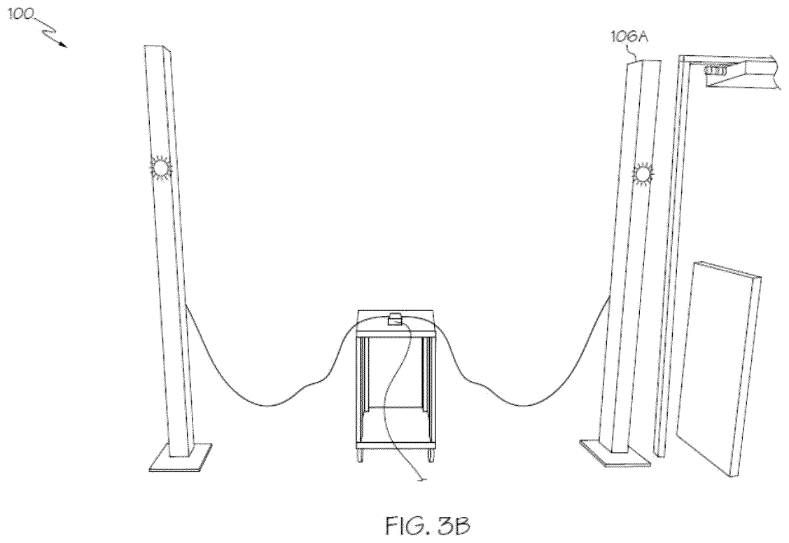

Referring to FIGS. 3A-B, there is shown illustrations of schematic diagrams of an inventory 300 (e.g., an inventory area) including the item identification system 100 deployed therein, in accordance with various embodiments of the present subject matter. The inventory 300 includes a plurality of racks 302 (e.g. shelves) adapted to store a plurality of items therein. The item identification system 100 may include the plurality of indicators 106A and 106B placed within a bay area of the plurality of racks 302. The plurality of indicators 106A-B includes green colored indicators 106A and red colored indicators 106B. In some embodiments, the green colored indicators 106A indicates availability of the items and the red colored indicators 106B indicate a location of the item. Furthermore, on identification and location of the selected item, an illuminated indicator 306 signifies the location of the selected item. In FIG. 3B, the indicator 106A may be mounted on a device or structure such as a portal reader.

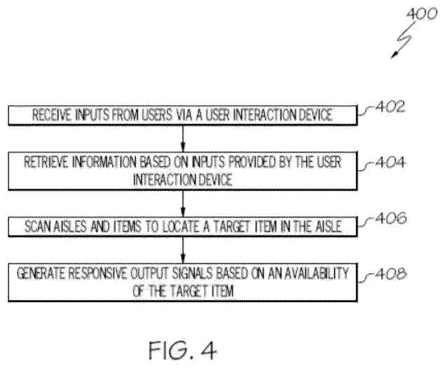

Referring to FIG. 4, there is shown an illustration of a flow chart of a method 400 for locating an item, in accordance with an exemplary embodiment of the present subject matter.

At an operation 402, users provide inputs via a user interaction device 102. For example, a desired item may be selected from a plurality of items. In such an instance, information about the desired item is enquired on the user interaction device. Such as for example, the desired item is an orange juice, so the information will include item is juice of orange flavor and of an ABC company with a selected quantity and a combination thereof.

At an operation 404, information is retrieved based on inputs provided by the user interaction device. The information about the item if compared from pre-stored data available therein. In some embodiments, the pre-stored data is stored in computers or memory drives and retrieved therefrom.

At an operation 406, racks and items are scanned to locate a target item in the racks. The racks and/or aisles are scanned to detect wireless identification tags to locate the item in the racks.

At an operation 408, a responsive output signal is generated based on an availability of the target item therein. The responsive output signal may include illumination of red and green indicators. In some embodiments, the responsive output signal causes illumination of one or more indicators 106 on the same item identifier 104 (e.g., to indicate direction and to help locate the item identifier). In some embodiments, the responsive output signal is relayed back to the user interaction device 102 and/or to the user's cell phone to indicate having found the item. In some embodiments, the responsive output signal is used to indicate what direction to travel from one item identifier 104 to travel towards the closest item identifier 104 near the requested item.

The operations 402 to 408 are only illustrative and other alternatives can also be provided where one or more steps are added, one or more steps are removed, or one or more steps are provided in a different sequence without departing from the scope of the claims herein. In some embodiments, the method includes signaling responsive output signal via a plurality of indicators. Furthermore, the responsive output signal includes signaling an audible alert from the plurality of indicators. In another embodiment, the responsive output signal includes signaling a visual alert from the plurality of indicators. In various embodiments, the visual alert from the plurality of indicators includes illuminating a plurality of lights.

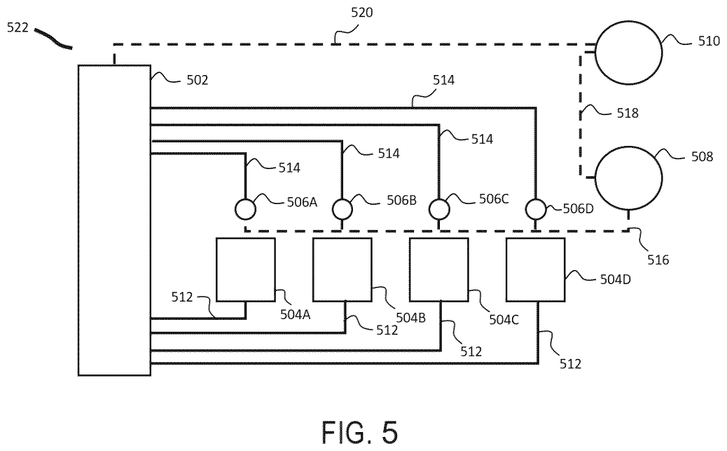

Referring to FIG. 5, in some embodiments, the item identification system 100 may include an item identifier 522 that in turn includes an RFID reader 502, antennas 504A, 504B, 504C, and 504D, directional indicators 506A, 506B, 506C, 506D, a position indicator 508, a row indicator 510, traces 512, 514, 516, 518, and 520.

In some embodiments, if one of the directional indicators 506A, 506B, 506C, 506D is lit, both of the position indicator 508 and the row indicator 510 (e.g., larger, brighter, or differently positioned lights) are lit. In some embodiments, position indicator 508 and the row indicator 510 are part of the electrical return path to ground, completing the circuit path for the directional indicators 506A, 506B, 506C, 506D.

In various embodiments, the RFID reader 502 may operate all of the antennas 504A-D when it receives a request to search for an item. When the requested item has been found by one or more of the antennas 504A-D, then the RFID reader 502 may then send a signal via trace 514 to illuminate the indicator 506A-D corresponding to the antennas 504A-D that detected the RFID tag associated with the searched for item. In various embodiments, given the orientation of the antennas 504A-D, only one or two antennas 506A-D should be oriented to detect an item on a shelf, with the other antennas being directed in oppositely oriented directions in the same plane. The position indicator 508 may include or be a dome light mounted on a surface (e.g., a bottom center, top, or lateral side) of an item identifier 104, such as within an area defined by the directional indicators 506A-D mounted on the item identifier 104. The row indicator 510 may also be illuminated when the position indicator 508 is illuminated. In various embodiments, the wiring for the indicators 506A-D, the position indicator 508, and the row indicator 510 may be connected via traces 514, 516, 518, and 520 to improve reliability and to reduce costs. In other embodiments, other wiring may be used, and the row indicator 510 may be absent or there may be multiple row indicators 510 used. Likewise, position indicator 508 may comprise a single light, a plurality of lights, and/or other indicators such as speakers or horns.

Modifications to embodiments of the present subject matter described in the foregoing are possible without departing from the scope of the present subject matter as defined by the accompanying claims. Expressions such as “including”, “comprising”, “incorporating”, “have”, “is” used to describe and claim the present subject matter are intended to be construed in a non-exclusive manner, namely allowing for items, components or elements not explicitly described also to be present. Reference to the singular is also to be construed to relate to the plural.

What is claimed is:

1. An item identification system comprising:
a user interaction device configured to receive inputs from one or more users identifying a requested item;
at least one item identifier communicably coupled to the one or more user interaction devices, and adapted to receive inputs from the one or more users and to perform operations based on inputs provided;
a plurality of antennas, and
a plurality of indicators operatively coupled to the at least one item identifier, and adapted to transmit a responsive output signal based on inputs received from the at least one item identifier and at least one of the plurality of antennas, the responsive output signal indicating a relative direction of the requested item and a position of an antenna that provided an input.

2. The item identification system according to claim 1, wherein the plurality of indicators are static devices installed in static platforms.

3. The item identification system according to claim 1, wherein the responsive output signal includes an audible alert from the plurality of indicators.

4. The item identification system according to claim 1, wherein the responsive output signal includes a visual alert from the plurality of indicators.

5. The item identification system according to claim 4, wherein the visual alert from the plurality of indicators includes polychromatic lights.

6. The item identification system according to claim 1, wherein the plurality of indicators is provided to an aisle indicator located at an end of an aisle.

7. The item identification system according to claim 1, wherein the at least one item identifier is configured as a multi-sided pyramid, each facing having a transmitter.

8. The item identification system according to claim 1, wherein the responsive output signal is based on an availability of an item in an aisle.

9. The item identification system according to claim 1, wherein the at least one item identifier relays the information to at least one item identifier located at another location in proximity.

10. The item identification system according to claim 1, wherein the at least one user interaction device is further configured to provide signal to a proximity indicator based on the at least one user interaction device in proximity to a wireless identification tag.

11. The item identification system according to claim 1, further comprises a user interface communicably coupled to the at least one item identifier.

12. A method for locating an item using an item identification system, comprising:
using a user interaction device, receiving inputs from one or more users identifying a requested item;
using at least one item identifier communicably coupled to the one or more user interaction devices, receiving inputs from the one or more users and performing operations based on inputs provided;
using a plurality of antennas and the at least one item identifier, providing inputs to at least one of the plurality of indicators, and
using the plurality of indicators and based on the inputs, providing a responsive output indicating a relative direction of the requested item and a position of an antenna that provided an input.

13. The method according to claim 12, wherein the responsive output signal includes signaling via a plurality of indicators.

14. The method according to claim 13, wherein the responsive output signal includes signaling an audible alert from the plurality of indicators.

15. The method according to claim 13, wherein the responsive output signal includes signaling a visual alert from the plurality of indicators.

16. The method according to claim 13, wherein the visual alert from the plurality of indicators includes illuminating a plurality of lights.
